(19) United States
(12) Patent Application Publication
(10) Pub. No.: US 2009/0141608 A1
(43) Pub. Date: Jun. 4, 2009

(54) OPTICAL RECORDING MEDIUM WITH BRAILLE CHARACTERS AND METHOD OF MANUFACTURING THE SAME

(75) Inventor: Chun-Nan CHEN, Erlun Township (TW)

Correspondence Address: Muncy, Geissler, Olds & Lowe, PLLC, P.O. BOX 1364, FAIRFAX, VA, 22038-1364, US

(73) Assignee: Daxon Technology Inc.

(21) Appl. No.: 12/133,933

(22) Filed: Jun. 5, 2008

(30) Foreign Application Priority Data
Nov. 30, 2007 (TW) 096145510

(51) Int. Cl. G11B 7/00; B32B 38/00

(52) U.S. Cl. 369/94; 156/281; 156/242

(57) ABSTRACT

The invention discloses an optical recording medium comprising a first substrate, a second substrate, a median layer and an adhesive layer. A plurality of Braille characters is formed on the second substrate by injection molding. The median layer is formed on the first substrate. The second substrate is adhered to the median layer by the adhesive layer. Accordingly, a visually-impaired person can easily identify the contents in the optical recording medium by touching the Braille characters on the second substrate.

### BACKGROUND OF THE INVENTION

1. Field of the Invention

The invention relates to an optical recording medium and, more particularly, to an optical recording medium with Braille characters and a manufacturing method thereof.

2. Description of the Prior Art

In recent years, low cost, high capacity, and easy portability of optical disks make the applications of them more and more popular. Optical disks can be used for recording information such as text, images, music, videos, and so on. In order to easily identify the contents in an optical disk, users usually affix tags to or write words on the surface of the optical disk, or he/she can print words on the tag surface of the optical disk by LightScribe.

However, for visually impaired people, how to identify the contents in optical disks is a big problem. So far there are no optical disks specially designed for visually impaired people. The patent with publication number 200641817 in Taiwan can be viewed as a relative prior art. This patent discloses a method for forming an image tag by selectively removing polycarbonate material from the non-data surface of an optical disk. The image tag can be formed as letters, Braille characters, dot-matrix holes, embossments, and so on. However, this prior art has the drawbacks of: (1) inability to be copied conveniently and largely, (2) high costs in repairing the manufacturing equipment, and (3) higher technical threshold.

Therefore, the scope of the invention is to provide an optical recording medium with Braille characters and a manufacturing method thereof to solve the aforesaid problems.

### SUMMARY OF THE INVENTION

The present invention is to provide an optical recording medium and a manufacturing method thereof. For the optical recording medium with two substrates (such as DVD, HD-DVD, and so on), the invention utilizes an injection molding process to form Braille characters on the substrate of the non-data surface, so as to enable visually impaired people to identify the contents in the optical recording medium.

In an embodiment, the optical recording medium of the invention includes a first substrate, a second substrate, a median layer, and an adhesive layer. A plurality of Braille characters is formed on the second substrate. The median layer is formed on the first substrate. The second substrate is adhered to the median layer via the adhesive layer. In addition, one side of the first substrate is provided as the data surface of the optical recording medium, and one side of the second substrate is provided as the non-data surface of the optical recording medium.

Thereby, visually impaired people can easily identify the contents in the optical recording medium via the Braille characters on the second substrate.

The advantage and spirit of the invention may be understood by the following recitations together with the appended drawings.

### BRIEF DESCRIPTION OF THE APPENDED DRAWINGS

FIG. 1 illustrates a schematic diagram of the optical recording medium in an embodiment according to the invention.

FIG. 2 is a cross-sectional view diagram of the optical recording medium along the X-X line in FIG. 1.

FIG. 3 illustrates a schematic diagram of the optical recording medium in another embodiment according to the invention.

FIG. 4A through FIG. 4E illustrates the manufacturing flow chart of the optical recording medium in FIG. 2.

### DETAILED DESCRIPTION OF THE INVENTION

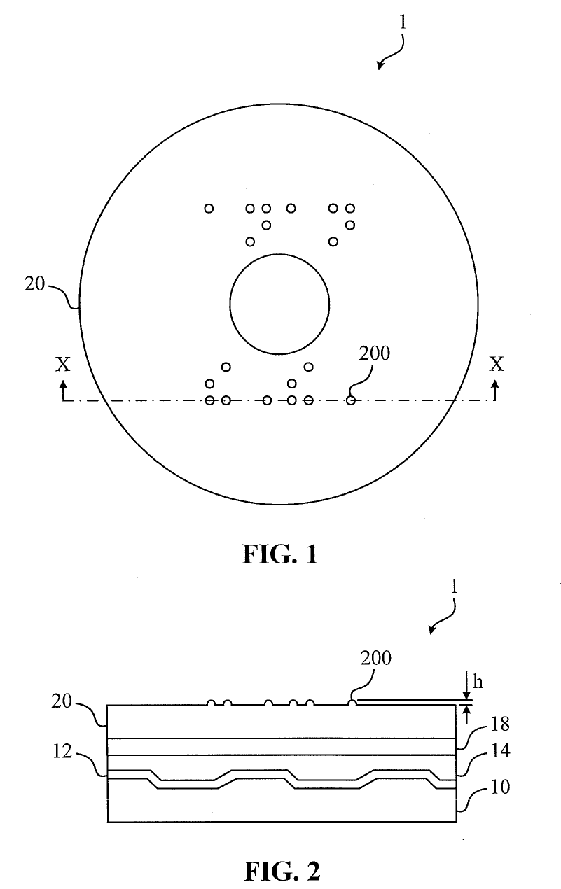

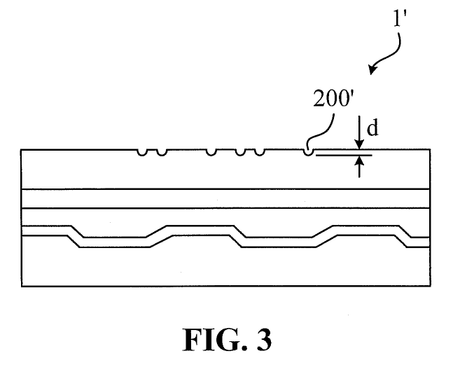

Please refer to FIG. 1 and FIG. 2. FIG. 1 illustrates a schematic diagram of an optical recording medium 1 in an embodiment according to the invention. FIG. 2 illustrates a cross-section diagram of the optical recording medium along X-X line in FIG. 1.

As shown in FIG. 2, the optical recording medium 1 includes a first substrate 10, a recoding layer 12, a reflecting layer 14, an adhesive layer 18, and a second substrate 20. One side of the first substrate 10 is provided as a data surface of the optical recording medium 1, and one side of the second substrate 20 is provided as a non-data surface of the optical recording medium 1. The material of the first substrate 10 and the second substrate 20 can be one selected from the group consisting of: PC, PE, PP, PVC, PMMA, and similar materials. The recording layer 12 is coated on the first substrate 10 and can be made of organic dye.

In this embodiment, the optical recoding medium 1 can be an optical disk, such as DVD, HD-DVD, and so on. In actual applications, the read/write head of an optical drive (not shown) can write data into and read data from the first substrate 10. A median layer includes the recording layer 12 and the reflecting layer 14.

The reflecting layer 14 is sputtered on the recording layer 12 and used for reflecting the laser beam issued from the read/write head. The adhesive layer 18 is coated on the reflecting layer 14. In this embodiment, an injection molding process is utilized to form a plurality of Braille characters 200 on the second substrate 20, and then the second substrate 20 is adhered to the adhesive layer 18. Thereby, visually impaired people can identify the contents in the optical recording medium 1 via the Braille characters 200 on the second substrate 20. As shown in FIG. 2, each of the Braille characters 200 is a convex dot, and a height (h) of each convex dot ranges between 0.05 mm and 0.3 mm.

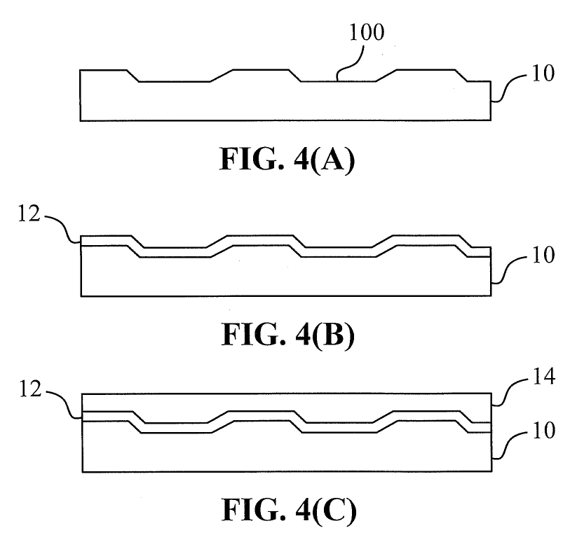

Please refer to FIG. 3, which is a schematic diagram of an optical recording medium 1′ in another embodiment of the invention. The major difference between the optical recording medium 1′ and the optical recording medium 1 is that the Braille characters 200′ of the optical recording medium 1′ are concave dots. In this embodiment, the depth (d) of the concave dot also ranges between 0.05 mm and 0.3 mm.

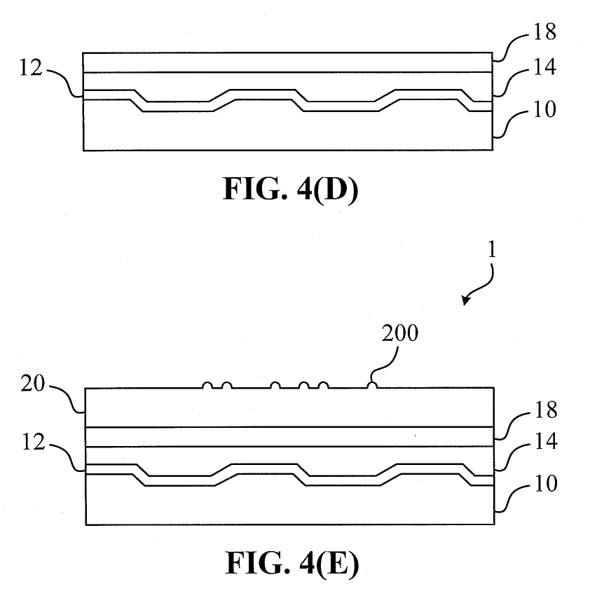

Please refer to FIG. 4A through FIG. 4F. FIG. 4A through FIG. 4F illustrate a manufacturing flow of the optical recording medium 1. At first, as shown in FIG. 4A, a first substrate 10 having grooves 100 previously formed thereon is provided. Then, as shown in FIG. 4B, a recording layer 12 is coated on the first substrate 10 by a spin coating method. And further, as shown in FIG. 4C, a reflecting layer 14 is sputtered on the recording layer 12. As shown in FIG. 4D, an adhesive layer 18 is then coated on the reflecting layer 14. At last, as shown in FIG. 4E, the second substrate 20 with a plurality of Braille characters 200 is adhered to the adhesive layer 18. Thereby, the manufacturing of the aforesaid optical recording medium 1 is completed.

It should be noted that the above median layer structure including the recording layer 12 and the reflecting layer 14 is only an exemplary embodiment according to the invention. In other words, in actual applications, the median layer structure may vary with the type of optical recording medium 1, such as DVD-R, DVD-RW, DVD+R, DVD+RW, DVD-RAM, HD-DVDE, and so on.

The invention utilizes the injection molding process to form Braille characters on a non-data surface so that visually impaired people can easily identify the contents in the optical recording medium. Compared to the prior arts, the invention has the advantages of: (1) ability to be copied conveniently and largely, (2) low costs in repairing the manufacturing equipment, and (3) lower technical threshold.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical recording medium with a plurality of Braille characters, comprising:
a first substrate;
a median layer formed on the first substrate;
a second substrate with a plurality of Braille characters formed thereon; and
an adhesive layer for adhering the second substrate to the median layer.

2. The optical recording medium of claim 1, wherein the material of the first substrate and the second substrate is one selected from the group consisting of: PC, PE, PP, PVC, and PMMA.

3. The optical recording medium of claim 1, wherein each of the Braille characters is a convex dot.

4. The optical recording medium of claim 3, wherein a height of the convex dot ranges between 0.05 mm and 0.3 mm.

5. The optical recording medium of claim 1, wherein each of the Braille characters is a concave dot.

6. The optical recording medium of claim 5, wherein a depth of the concave dot ranges between 0.05 mm and 0.3 mm.

7. The optical recording medium of claim 1, wherein the median layer comprises:
a recording layer coated on the first substrate; and
a reflecting layer sputtered on the recording layer;
wherein the adhesive layer is coated on the reflecting layer.

8. A manufacturing method of an optical recording medium with Braille characters, comprising the steps of:
providing a first substrate;
forming a median layer on the first substrate;
coating an adhesive layer on the median layer; and
adhering a second substrate having the Braille characters to the adhesive layer.

9. The manufacturing method of claim 8, wherein the Braille characters are formed on the second substrate by an injection molding process.

10. The manufacturing method of claim 8, wherein the material of the first substrate and the second substrate is one selected from the group consisting of: PC, PE, PP, PVC, and PMMA.

11. The manufacturing method of claim 8, wherein each of the Braille characters is a convex dot.

12. The manufacturing method of claim 11, wherein a height of the convex dot ranges between 0.05 mm and 0.3 mm.

13. The manufacturing method of claim 8, wherein each of the Braille characters is a concave dot.

14. The manufacturing method of claim 13, wherein a depth of the concave dot ranges between 0.05 mm and 0.3 mm.

15. The manufacturing method of claim 8, wherein the median layer comprises:
a recording layer coated on the first substrate; and
a reflecting layer sputtered on the recording layer;
wherein the adhesive layer is coated on the reflecting layer.
